(19) United States
(12) Patent Application Publication
(10) Pub. No.: US 2006/0171248 A1
(43) Pub. Date: Aug. 3, 2006

(54) Blender

(75) Inventor: Wenhung Chou, Taoyuan (TW)

Correspondence Address: HAMRE, SCHUMANN, MUELLER & LARSON, P.C., P.O. BOX 2902-0902, MINNEAPOLIS, MN, 55402, US

(73) Assignee: AIRLUX ELECTRICAL CO., LTD., Shenzhen City (CN)

(21) Appl. No.: 11/135,912

(22) Filed: May 24, 2005

(30) Foreign Application Priority Data
Feb. 3, 2005 (CN) 200520054749.0

(51) Int. Cl. B01F 15/06; A47J 43/046

(52) U.S. Cl. 366/149; 366/205; 366/249

(57) ABSTRACT

A blender includes a housing (1) and a container (3). A motor (11) is mounted in the housing. The container with an opening (30) at one end includes an inner wall (32), an outer wall (34) and a sealed cavum (36) being formed between the inner wall and the outer wall. Freezing medium is filled in the cavum. The container is removably connected with the housing.

### BACKGROUND OF THE INVENTION

1. Field of the Invention

The present invention relates to a blender, and particularly to a blender having a freezing-preservation function.

2. Description of the Prior Art

Generally, blender especially means an electrical appliance with whirling blades for chopping, mixing, or liquefying foods. A typical structure of a blender in prior art includes a housing and a container mounted on the housing. A spindle is connected to a power driven source in the housing. A top of the spindle extends into a bottom of the container and is connected to a blade in the container. The blade whirls for chopping, mixing, or liquefying foods. However, this conventional blender could not freeze the food therein. Usually, the user has to remove the container containing the food from the housing and puts it in a refrigeratory to keep the food fresh or cold, or pours the food into a cup and then put the cup in a refrigeratory, which brings a lot of trouble.

Thus, an improved blender which overcomes the above-mentioned problems is desired.

### BRIEF SUMMARY OF THE INVENTION

Accordingly, an object of the present invention is to provide a blender having a freezing-preservation function.

To achieve the above-mentioned objects, a blender in accordance with a preferred embodiment of the present invention is disclosed. The blender comprises a housing and a container removably connecting with the housing. A motor is mounted in the housing. The container being opening at one end comprises an inner wall, an outer wall and a sealed cavum being formed between the inner wall and the outer wall. Freezing medium is filled in the cavum.

Other objects, advantages and novel features of the present invention will become more apparent from the following detailed description when taken in conjunction with the accompanying drawings, in which:

### BRIEF DESCRIPTION OF THE DRAWINGS

FIG. 1 is an elevation view of a blender in accordance with the present invention;

FIG. 2 is a vertical sectional view of the blender of FIG. 1 along line A-A;

FIG. 3 is a vertical sectional view of the container of the blender in accordance with the present invention;

FIG. 4 is a an elevation view of a blender in accordance with another alternative embodiment of the present invention;

FIG. 5 is a an elevation view of a blender in accordance with further alternative embodiment of the present invention.

### DETAILED DESCRIPTION OF THE INVENTION

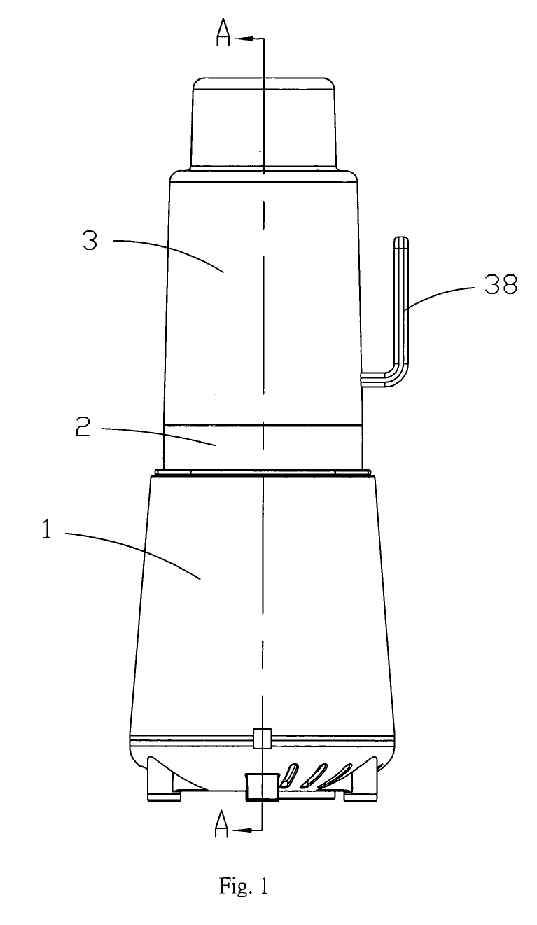

Referring to FIG. 1, a blender in accordance with a preferred embodiment of the present invention comprises a housing 1, a connecting member 2 and a container 3.

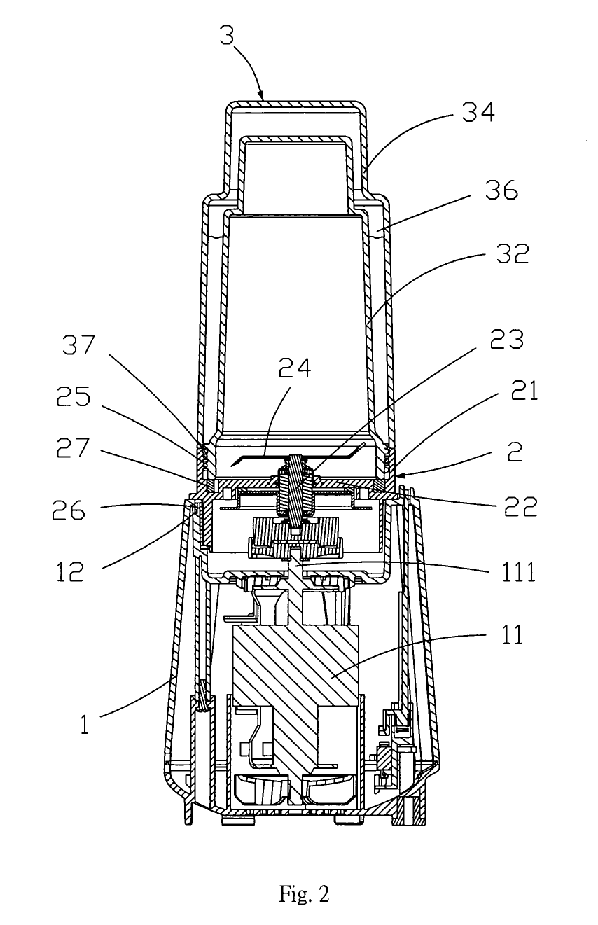

Referring to FIG. 2 together, the housing 1 has a motor 11 mounted therein. An output shaft 111 protrudes from the motor 11 upwardly. A plurality of fixing slots 12 is defined in a top of the housing 1.

The connecting member 2 is engaged in the top of the housing 1. The connecting member 2 comprises a cylinder 21 being vertically located at its outer periphery, and a plate 22 traverses through its middle inner space, thus a vertical section of the connecting member 2 forms an H-shape. A spindle 23 is vertically and rotatablely inserted through the plate 22 at its middle. A blade 24 locates above the plate 22 and is mounted at a top of the spindle 23. A lower portion of the spindle 23 being under the plate 22 is engaged with the output shaft 111 of the motor 11. The engagement between the spindle 23 and the output shaft 111 may be gearing. For instance, a first gear (not labeled) is fixed at a lower end of the spindle 23, and a second gear (not labeled) is fixed at a top end of output shaft 111 of the motor 11 and is coupled to the first gear. Internal thread 25 is formed around an inner surface of the cylinder 21 at an upper portion thereof. A plurality of hooks 26 is formed on an outer surface of the cylinder 21, and is inserted in the fixing slots 12. A sealed ring 27 is received in a recess (not labeled) defined in the plate 22.

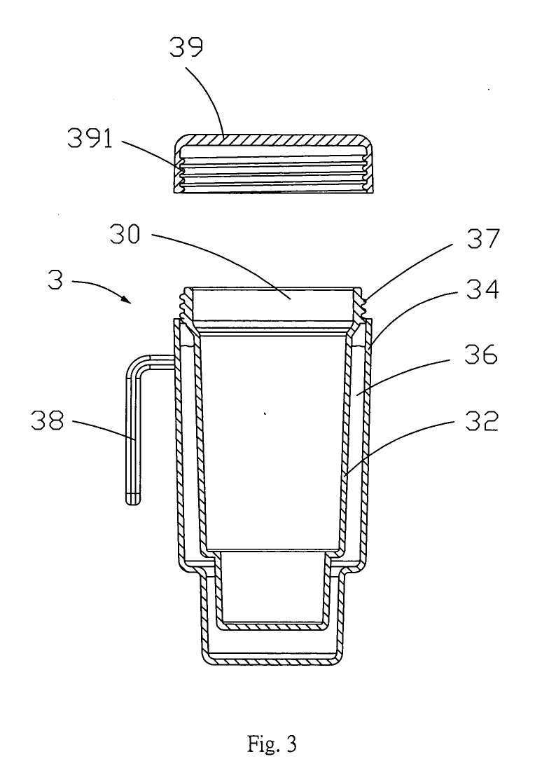

Referring to FIG. 3 together, the container 3 with an opening 30 being defined at a top thereof, comprises an inner wall 32, an outer wall 34 and a sealed cavum 36 formed between the inner wall 32 and the outer wall 34. Freezing or cooling medium is filled in the cavum 36. Outer thread 37 is formed around the outer wall 34 around the opening 30, and can be coupled to the internal thread 25 formed around the inner surface of the cylinder 21 when the container 3 is mounted to the connecting member 2. The container 3 further comprises a handle 38 on the outer wall 34. Moreover, a cap 39 is supplied for sealing the opening 30 after the container 3 is moved from the connecting member 2. Internal thread 391 is also formed at the cap 39 to engage with the outer thread 37 of the container 3.

Before using the blender, the container 3 is placed in a freezing equipment at a lower temperature for cooling a moment. When using the blender to process food, for instance, use the blender for extracting juice, the container 3 is taken out from the freezing equipment. Chipped fruit is filled in the container 3. The connecting member 2 is mounted to the container 3 at the opening 30. The internal thread 25 of the connecting member 2 is engaged with the outer thread 37 of the container 3, and the sealed ring 27 is engaged with the container 3 for sealing the container 3 around the opening 30 thereof, therefore, the container 3 is sealed. Herein, the blade 24 extends on the container 3. Then, the container 3 together with the connecting member 2 is turned upside down for being mounted onto the housing 1. The hooks 26 of the connecting member 2 are inserted in the fixing slots 12 of the housing 1. The bottom of the spindle 23 engages with the top of the output shaft 111 of the motor 11. The motor 11 is started to drive the blade 24 through the output shaft 111 and the spindle 23. The blade 24 whirls at a relatively high speed for cutting and grinding fruit into juice. After that, the motor 11 is stopped. The connecting member 2 and the container 3 are released together from the housing 1 and are turned upside down together again. Finally, the connecting member 2 is removed from the container 3, the cap 39 is covered onto the opening 30 of the container 3 and seals the same using thread. Thus, the juice can be freezing-preserved in the container 3 for a long time, and keep fresh.

In an alternative embodiment, the outer wall 34 further comprises a first outer wall, a second outer wall, thus forming a sealed space therebetween for being filled with freezing medium. Therefore, more freezing medium is available for freezing the juice, so that the juice can be freezing-preserved in the container 3 and keep fresh for a longer time.

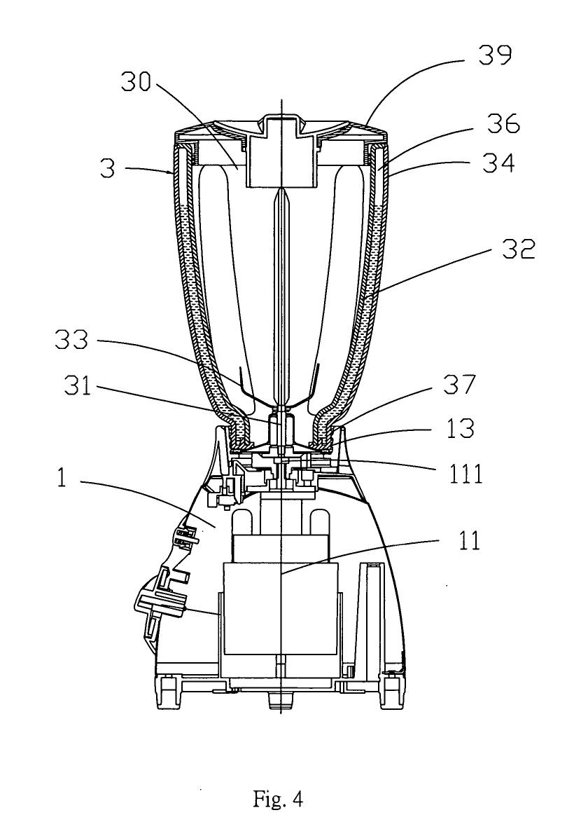

In another alternative embodiment as shown in FIG. 4, the blender also includes a housing 1 and a container 3. The container 3 can be removably mounted and sealed on a top of the housing 1 using thread.

The housing 1 has a motor 11 being mounted therein. An output shaft 111 protrudes from the motor 11 upwardly. Internal thread 13 is defined in a top of the housing 1.

The container 3 with an opening 30 being defined at a top thereof, comprises an inner wall 32, an outer wall 34 and a sealed cavum 36 formed between the inner wall 32 and the outer wall 34. Freezing or cooling medium is filled in the cavum 36. A spindle 31 vertically and rotatablely extends through a bottom of the container 3 at its middle to the housing for being engaged with the shaft 111. A blade 33 is supported at a top of the spindle 31 in the lower portion of the container 3. A lower portion of the spindle 31 extends out of the container 3 through the bottom thereof, and is engaged with the output shaft 111 of the motor 11. Outer thread 37 is formed around the outer wall 34 at the bottom of the container 3, and can be coupled to the internal thread 13 defined in a top of the housing 1 when the container 3 is mounted to the housing 1. Moreover, a cap 39 is supplied for sealing the opening 30.

Before using the blender as shown in FIG. 4, the container 3 is placed in a freezing equipment at a lower temperature for cooling. In using, it is not necessary to turn upside down the container 3 for mounting the same onto the housing 1. The outer thread 37 formed around the outer wall 34 at the bottom of the container 3 is coupled to the internal thread 13 defined in a top of the housing 1. The cap 39 is covered onto the opening 30 of the container 3 for sealing the opening 30. After that, the motor 11 is started to drive the blade 33 through the output shaft 111 and the spindle 31. The blade 33 whirls at a relatively high speed for cutting and grinding fruit into juice. Then, the motor 11 is stopped. The container 3 is released from the housing 1. Thus, the juice can be freezing-preserved in the container 3 for a long time, and keep fresh. Obviously, it is relatively convenient in use.

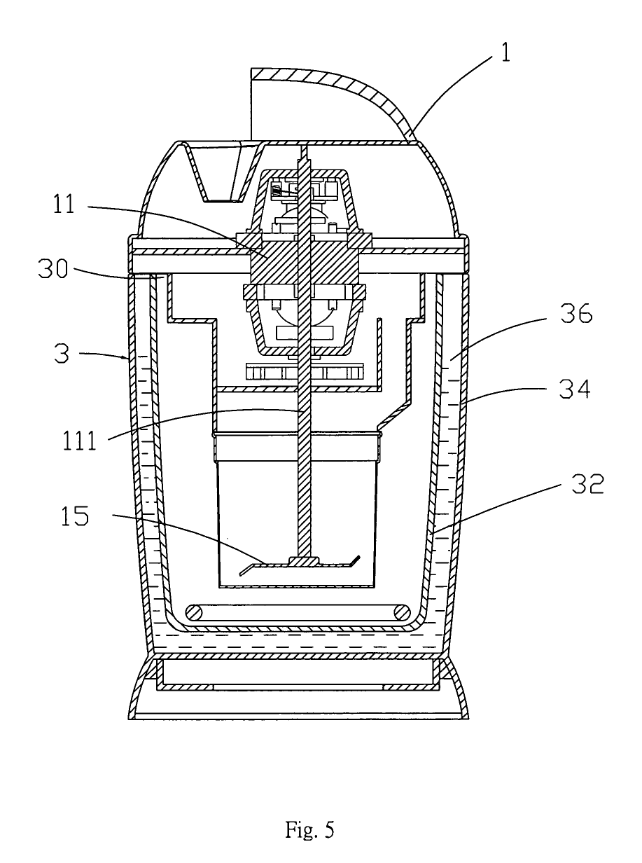

In further alternative embodiment as shown in FIG. 5, the blender is used as a soymilk maker, the blender also includes a housing 1 and a container 3. The container 3 can be removably mounted and sealed under the housing 1 using thread or clips.

The housing 1 has a motor 11 mounted therein. An output shaft 111 protrudes from the motor 11 downwardly. A blade 15 is mounted at a bottom end of the output shaft 111 in the container 3.

The container 3 with an opening 30 being defined at a top thereof, comprises an inner wall 32, an outer wall 34 and a sealed cavum 36 formed between the inner wall 32 and the outer wall 34. Freezing or cooling medium is filled in the cavum 36. The container 3 is removably mounted under the housing 1. The output shaft 111 and blade 15 are received in the container 3. Moreover, a cap (not shown in FIG. 5) is supplied for sealing the opening 30 after the container 3 is moved from the housing 1.

Before using the blender as shown in FIG. 5, the container 3 is placed in a freezing equipment at a lower temperature for cooling. In using, the opening 30 of the container 3 is sealed under the bottom of the housing 1. It is not necessary to turn upside down the container 3 for mounting the container 3 under the housing 1 so that it is convenient in use. The container 3 can be mounted and sealed to the housing 1 in various means, such as using threads or using an engagement between hooks and slots that are formed on the housing 1 and the container 3.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A blender comprising:
a housing with a motor being mounted therein; and
a container removably connecting with the housing;
wherein the container with an opening at one end, comprises an inner wall,
an outer wall and a sealed cavum being formed between the inner wall and
the outer wall, and freezing or cooling medium is filled in the cavum.

2. The blender as described in claim 1, wherein the blender further comprises a connecting member for removably connecting the container with the housing.

3. The blender as described in claim 2, wherein the connecting member is removably sealed the opening of the container using thread.

4. The blender as described in claim 3, wherein the connecting member comprises a cylinder being vertically located at an outer periphery thereof, and a plate traverses through an inner space of the connecting member for sealing the opening of the container.

5. The blender as described in claim 4, wherein a spindle is vertically and rotatablely inserted through the plate, a blade is supported at one end of the spindle and extends in the container, the other end of the spindle is engaged with an output shaft of the motor.

6. The blender as described in claim 5, wherein a first gear is fixed at a lower end of the spindle, a second gear is fixed at a top end of the output shaft of the motor and is coupled to the first gear.

7. The blender as described in claim 4, wherein internal thread is formed around an inner surface of the cylinder at an upper portion thereof, outer thread is formed around the outer wall of the container corresponding to the internal thread.

8. The blender as described in claim 4, wherein a plurality of fixing slots is defined in a top of the housing, a plurality of hooks is formed on an outer surface of the cylinder, corresponding to the fixing slots.

9. The blender as described in claim 4, wherein a sealed ring is set between the plate and the container around the opening thereof.

10. The blender as described in claim 1, wherein the outer wall further comprises a first outer wall, a second outer wall, and a sealed space is formed therebetween with freezing medium being filled therein.

11. The blender as described in claim 1, wherein the container further comprises a handle being formed on the outer wall, and a cap for sealing an opening of the container after the container is moved from the housing.

12. The blender as described in claim 1, wherein the container is removably sealed to the housing using thread or an engagement between hooks and slots.

13. The blender as described in claim 12, wherein the container is mounted on a top of the housing, an output shaft protrudes from the motor upwardly, a spindle is vertically and rotatablely inserted through a bottom of the container with one end being engaged with the output shaft of the motor and the other end supporting a blade in the container.

14. The blender as described in claim 13, wherein internal thread is defined in a top of the housing, outer thread is formed around the outer wall at the bottom of the container, corresponding to the internal thread.

15. The blender as described in claim 12, wherein the container is mounted under the housing with the opening being sealed to the housing, an output shaft protrudes from the motor downwardly, and a blade is mounted at a bottom of the output shaft in the container.

16. A blender comprising:
a housing; and
a container;
wherein the container removably connecting with the housing; the container with an opening at one end thereof, defines an inter space in a wall of the container for being filled with cooling or freezing materials.

17. The blender as described in claim 16, wherein the blender further comprises a connecting member for removably connecting the container with the housing, and the connecting member is removably sealed the opening of the container using thread.

18. The blender as described in claim 16, wherein the container is removably sealed to the housing using thread or an engagement between hooks and slots.

19. The blender as described in claim 18, wherein the container is mounted on a top of the housing with a bottom of the container engaging with the housing, internal thread is defined in a top of the housing, outer thread is formed around the outer wall at the bottom of the container, corresponding to the internal thread, a blade which is driven by a motor in the housing is supported in the container.

20. The blender as described in claim 18, wherein the container is mounted under the housing with the opening being sealed to the housing, an output shaft protrudes from an motor in the housing downwardly, and a blade is mounted at a bottom of the output shaft in the container.
